(19) United States
(12) Patent Application Publication
(10) Pub. No.: US 2017/0278073 A1
(43) Pub. Date: Sep. 28, 2017

(54) TASK MANAGEMENT DEVICE AND TASK MANAGEMENT METHOD

(71) Applicant: CASIO COMPUTER CO., LTD., Tokyo (JP)

(72) Inventor: Keita ANJO, Tokyo (JP)

(73) Assignee: CASIO COMPUTER CO., LTD., Tokyo (JP)

(21) Appl. No.: 15/439,645

(22) Filed: Feb. 22, 2017

(30) Foreign Application Priority Data
Mar. 23, 2016 (JP) 2016-058530

(51) Int. Cl. G06Q 10/10

(52) U.S. Cl. CPC G06Q 10/1097; G06F 3/04817

(57) ABSTRACT

A task management device includes a first receiver which receives an entry of task information including letter string information as content information of a task; and a first display controller which, in a case where the first receiver receives the entry of the task information, generates a stamp mark on a basis of the letter string information in the task information, places and shows the generated stamp mark in a predetermined schedule template.

### BACKGROUND OF THE INVENTION

1. Field of the Invention

The present invention relates to a task management device and a task management method.

2. Description of Related Art

Traditionally, there is known a to-do task management device for managing the tasks which need to be carried out by a user.

Further, there is known an information processing device which is shared among a plurality of users in a family for displaying a message which is input by an arbitrary user at the time when the device is turned on and further showing schedules on a calendar (see JP Hei9-120418).

### SUMMARY OF THE INVENTION

In the above traditional information processing device, when displaying tasks as schedules, displaying can be confusing if number of schedules are entered and the letter strings of the schedules are difficult to be recognized.

An object of the present invention is to make the contents of the tasks which need to be carried out be recognized easily and to support so as to assure that the tasks will be carried out.

According to an aspect of the present invention, there is provided a task management device including: a first receiver which receives an entry of task information including letter string information as content information of a task; and a first display controller which, in a case where the first receiver receives the entry of the task information, generates a stamp mark on a basis of the letter string information in the task information, places and shows the generated stamp mark in a predetermined schedule template.

According to another aspect of the present invention, there is provided a task management device, comprising: a first receiver which receives an entry of task information including identification information for identifying an application which is activated when carrying out a task; and a first display controller which, in a case where the first receiver receives the entry of the task information, generates or selects a stamp mark on a basis of the identification information corresponding to the task information, and places and shows the stamp mark which is generated or selected in a predetermined schedule template.

According to still another aspect of the present invention, there is provided a task management method including: first receiving to receive an entry of task information including letter string information as content information of a task; and first display controlling in which, in a case where the entry of the task information is received in the first receiving, a stamp mark is generated on a basis of the letter string information in the task information, and the generated stamp mark is placed and shown in a predetermined schedule template.

According to the present invention, the contents of the tasks which need to be carried out can be recognized easily and the users can be supported so as to assure that the tasks will be carried out.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 is a block diagram showing the task management system according to an embodiment of the present invention;

FIG. 2 is a block diagram showing the functional structure of a server;

FIG. 3 is a block diagram showing the functional structure of a terminal device;

FIG. 4 shows the structure of an account data table;

FIG. 5 shows the structure of a task data table;

FIG. 6 is a flowchart of an information display input process;

FIG. 7 is a flowchart of a task communication process;

FIG. 8A shows the first task communication screen;

FIG. 8B shows the second task communication screen;

FIG. 9A shows the third task communication screen;

FIG. 9B shows the fourth task communication screen;

FIG. 10 shows the fifth task communication screen;

FIG. 11A shows the sixth task communication screen; and

FIG. 11B shows the seventh task communication screen.

### DESCRIPTION OF THE PREFERRED EMBODIMENT

Hereinafter, an embodiment of the present invention will be described in detail with reference to the drawings. However, the present invention is not limited to the examples shown in the drawings.

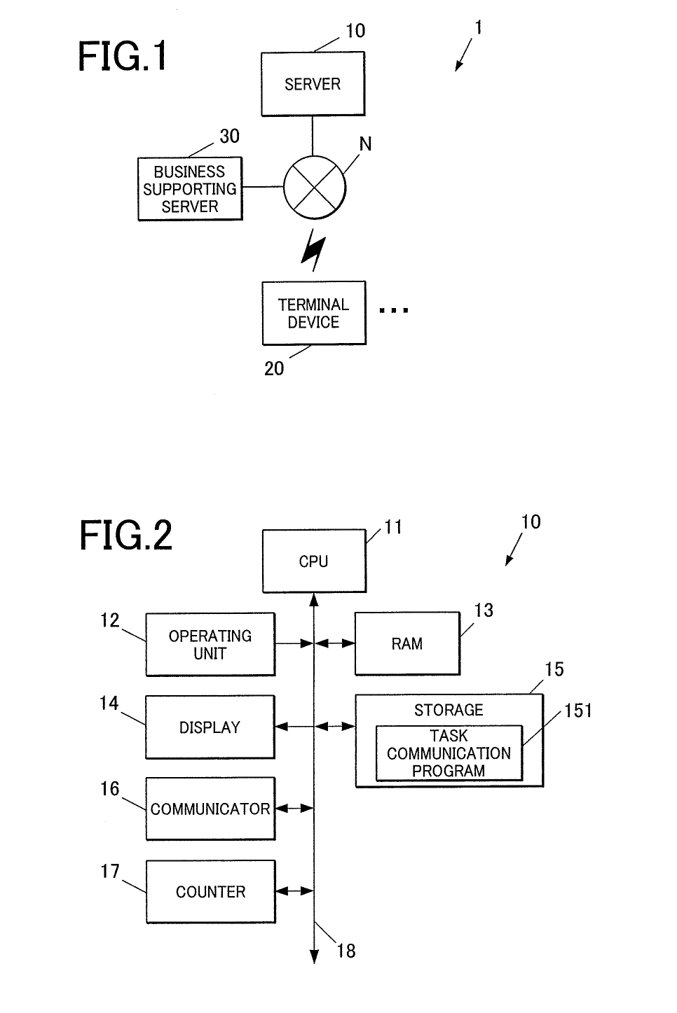

With reference to FIGS. 1 to 3, the device structures according to the embodiment will be described. With reference to FIG. 1, the task management system 1 of the embodiment will be described. FIG. 1 is a block diagram showing the task management system 1 of the embodiment.

The task management system 1 includes a server 10, a plurality of terminal devices 20 as displays and a business supporting server 30. In the embodiment, a case where the task management system 1 is a system shared among a plurality of staffs (owner, manager, part time staffs, etc.) who work at a privately owned restaurant is taken as an example. However, the present invention is not limited to be applied to such situation.

The server 10 is a server which is connected to a communication network N and manages displaying of information relating to tasks (to-do tasks) which need to be carried out by the users of the terminal devices 20 in the terminal devices 20. The communication network N is the Internet. However, the communication network N may be other networks such as LAN (Local Arear Network), etc.

The terminal devices 20 are portable terminal devices owned by the users who are the staffs at the restaurant. Here, a case where the terminal devices 20 are smartphones is taken as an example to be described. However, this is not limitative in any way. The terminal devices 20 may be other portable terminal devices such as tablet type PCs (Personal Computers), mobile phones, PDAs (Personal Digital Assistants), laptop PCs, etc. or other terminal devices such as desktop PCs, etc. The terminal devices 20 receive inputs such as operations carried out by the users, send the inputs to the server 10 and displays the information received from the server 10. The terminal devices 20 are further connected to a communication network N via abase station, access points (both not shown), etc. of the communication network N.

With respect to the task management system 1, the information relating to the tasks which are to be carried out by the users of the plurality of terminal devices 20 is managed by the server 10. However, this is not limitative in any way. The task management system 1 may only include one terminal device 20 owned by a private user or the task management system 1 may include one terminal device 20 shared by a plurality of users.

The business supporting server 30 is connected to the communication network N and provides various types of services which support business tasks relating to the restaurant management to the terminal devices 20. As the processes corresponding to various types of services supporting business tasks, the business supporting server 30 carries out the salary management process which manages the information relating to salary payment, the accounting management process which manages the information relating to accounting and the personal task management process which manages the tasks personally entered by the staffs. The salary management process provides a salary payment service by carrying out the salary payment application (application program), and at least generates information corresponding to the tasks relating to salary payment management. The accounting management process provides an accounting service by carrying out the accounting application, and at least generates information corresponding to the tasks relating to accounting management. Through the personal task management process, entering, managing and completion setting of the personal tasks which need to be carried out can be carried out. The business supporting server 30 compiles the information relating to tasks generated in the salary payment management process, the accounting management process and the personal task management process, stores the information in the after-mentioned task data table 50 and updates the information as needed. The processes carried out by the business supporting server 30 are not limited to the above mentioned processes, and any processes can be carried out by the business supporting server 30 as long as the processes at least involve management of generating, entering and the like of tasks.

With reference to FIG. 2, the functional structure inside the server 10 will be described. FIG. 2 is a block diagram showing the functional structure of the server 10.

As shown in FIG. 2, the server 10 includes a CPU (Central Processing Unit) 11 as a first display controller and a second display controller, an operating unit 12, a RAM (Random Access Memory) 13, a display 14, a storage 15, a communicator 16 as a receiver and a counter 17. The individual units of the server 10 are connected to each other via a bus 18.

The CPU 11 controls the individual units of the server 10. The CPU 11 reads out the specified program among the system program and the application programs stored in the storage 15, deploys the specified program in the RAM 13 and carries out various types of processes in cooperation with the program.

The operating unit 12 includes a key input unit such as a key board or the like and a pointing device such as a mouse or the like. The operating unit 12 receives key inputs and position inputs, and outputs the operating information relating to the inputs to the CPU 11.

The RAM 13 is a volatile memory and forms a work area for temporarily storing various types of data and programs. The display 14 is configured by including a LCD (Liquid Crystal Display), an EL (Electroluminescent) display or the like and carries out various types of displays in accordance with the display information instructed by the CPU 11.

The storage 15 is configured by including a HDD (Hard Disk Drive), a SSD (Solid State Drive) or the like and data and programs can be written in and can be read out. Specifically, in the storage 15, the task communication program 151 and the after-mentioned account data table 40 are stored.

The communicator 16 is configured by including a network card or the like and is connected to the communication network N so as to carry out communication with other devices included in the communication network N. The CPU 11 can communicate with the terminal devices 20 in the communication network N via the communicator 16.

The counter 17 is a real time clock. The counter 17 counts the current date and time and outputs the counted current date and time information to the CPU 11.

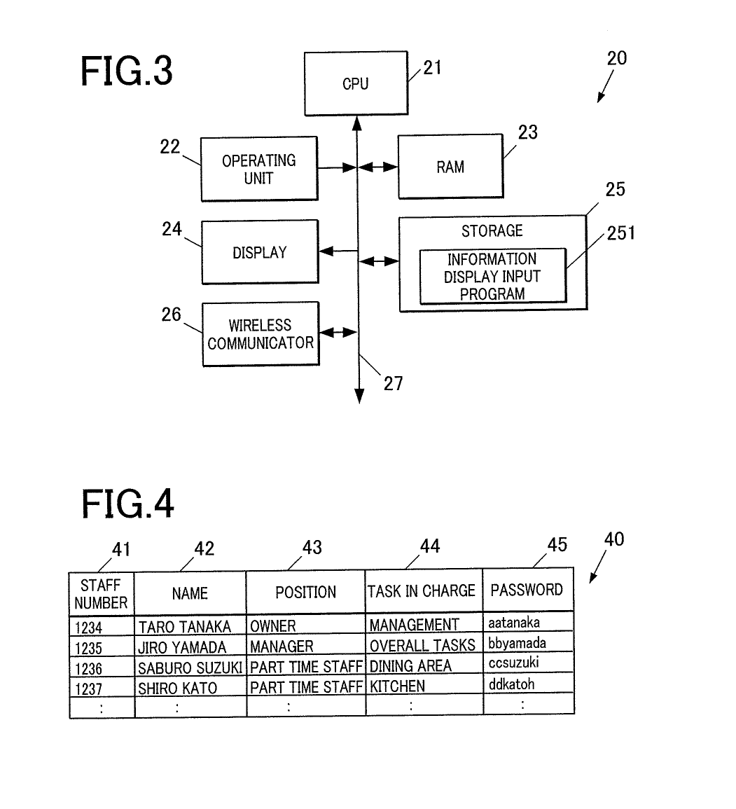

With reference to FIG. 3, the functional structure of a terminal device 20 will be described. FIG. 3 is a block diagram showing the functional structure of a terminal device 20.

A terminal device 20 includes a CPU 21, an operating unit 22, a RAM 23, a display 24, a storage 25 and a wireless communicator 26. The individual units of the terminal device 20 are connected to each other via a bus 27.

Since the CPU 21, the RAM 23 and the display 24 are the same as the CPU 11, the RAM 13 and the display 14 of the server 10, their overlapping description will be omitted and the different aspects will be mainly described.

The CPU 21 controls the individual units of the terminal device 20. The operating unit 22 includes a touch panel which is provided on the display screen of the display 24. The operating unit 22 receives touch inputs carried out by a user and outputs the operating information relating to the touch inputs to the CPU 21.

The storage 25 is configured by including a flash memory, an EEPROM (Electrically Erasable Programmable ROM) or the like and data and programs can be written in and can be read out. Specifically, in the storage 25, the information display input program 251 is stored.

The wireless communicator 26 includes an antenna, a modulation and demodulation circuit, a signal processing circuit and the like and carries out sending and receiving of information with a base station, access points, etc. in the communication network N through wireless radio wave.

Therefore, the CPU 21 can communicate with the server 10 by the wireless communicator 26 via abase station, access points, etc. in the communication network N. With respect to the terminal device 20 as a smartphone, other configuration units such as an audio input and output unit and a positioning unit are omitted in the drawings and their description is also omitted.

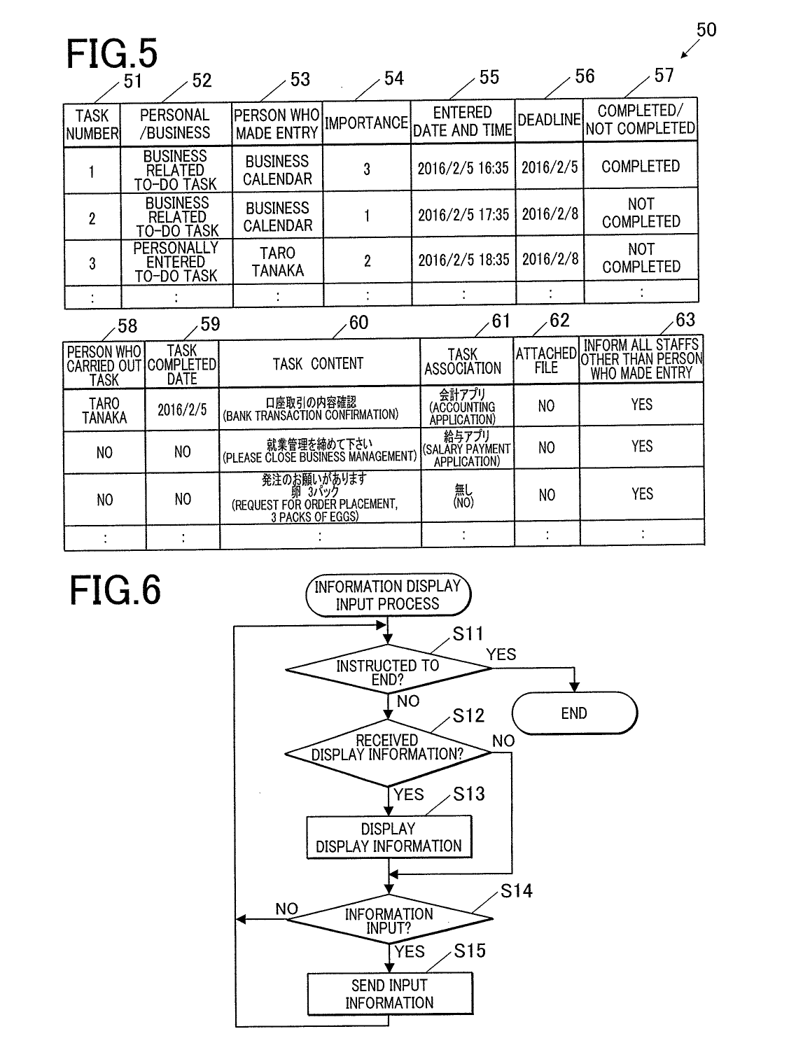

With reference to FIGS. 4 and 5, the account data table 40 stored in the storage 15 of the server 10 and the task data table 50 stored in the business supporting server 30 will be described. FIG. 4 shows the structure of the account data table 40. FIG. 5 shows the structure of the task data table 50.

The account data table 40 is a table including account information of the staffs at the restaurant (users of the terminal devices 20). As shown in FIG. 4, the account data table 40 includes columns such as staff number 41, name 42, position 43, task in charge 44 and password 45.

The staff numbers 41 indicate the identification information of the staffs at the restaurant and in the embodiment, the identification information also functions as login IDs. The names 42 indicate the name information of the staffs indicated by the staff numbers 41. The positions 43 indicate the position information of the staffs indicated by the staff numbers 41. The task in charge 44 indicates the information relating to the tasks and task areas which each of the staffs indicated by the staff numbers 41 is in charge of. The passwords 45 indicate the password information of the staffs indicated by the staff numbers 41.

The task data table 50 is a table including information relating to the entered tasks. The task data table 50 includes columns such as task number 51, personal/business 52, person who made the entry 53, importance 54, entered date and time 55, deadline 56, completed/not completed 57, person who carried out the task 58, task completed date 59, task content 60, task association 61, attached file 62 and whether to inform all staffs other than the person who made the entry 63.

The task numbers 51 indicate the identification information of the entered tasks. The personal/business 52 is information which indicates whether each of the tasks indicated by the task numbers 51 is a personally entered to-do task which is entered personally by a staff using a terminal device 20 through the personal task management process in the business supporting server 30 or a business related to-do task generated through the salary management process or the accounting management process in the business supporting server 30.

The person who made the entry 53 indicates the name of the person who entered each of the tasks indicated by the task numbers 51. In the embodiment, the person who made the entry 53 is the name of the person who personally made the entry for a personally entered to-do task and is the business calendar for all business related to-do tasks. The importance 54 indicates the importance (priority) information in terms of carrying out each of the tasks indicated by the task numbers 51. The entered date and time 55 indicates the entered date and time information of each of the tasks indicated by the task numbers 51. The deadlines 56 indicate the deadline information by when the tasks indicated by the task numbers 51 need to be completed. The completed/not completed 57 indicates the condition information of each of the tasks indicated by the task numbers 51 whether it is completed or not completed. The person who carried out the task 58 indicates the name of the person, who is a staff, who carried out each of the tasks indicated by the task numbers 51. The task completed dates 59 indicate the date information when the tasks indicated by the task numbers 51 were completed.

The task contents 60 indicate the content information of the tasks indicated by the task numbers 51. The task association 61 indicates the name (accounting application, salary payment application) of the business supporting service application (program) such as the accounting service, the salary payment service or the like which is associated with each of the tasks indicated by the task numbers 51. The application indicated by the task association 61 is the application which generated each of the tasks indicated by the task numbers 51 and is the application which is activated in the business supporting server 30 and by which each of the tasks is carried out when the user who confirmed each of the tasks indicated by the task numbers 51 carries out the task.

The attached files 62 indicate the names of the attached files such as text files which are input in association with the tasks indicated by the task numbers 51. With respect to each of the tasks indicated by the task numbers 51, whether to inform all staffs other than the person who made the entry 63 indicates whether to display the task information so as to inform all staffs other than the person who made the entry of the task information. If “yes” is indicated for weather to inform all staffs other than the person who made the entry 63, such tasks will be displayed in the terminal devices of all the staffs at the restaurant including the person who made the entry. If “no” is indicated for weather to inform all staffs other than the person who made the entry 63, such tasks will only be displayed in the terminal device of the person who made the entry among the staffs at the restaurant.

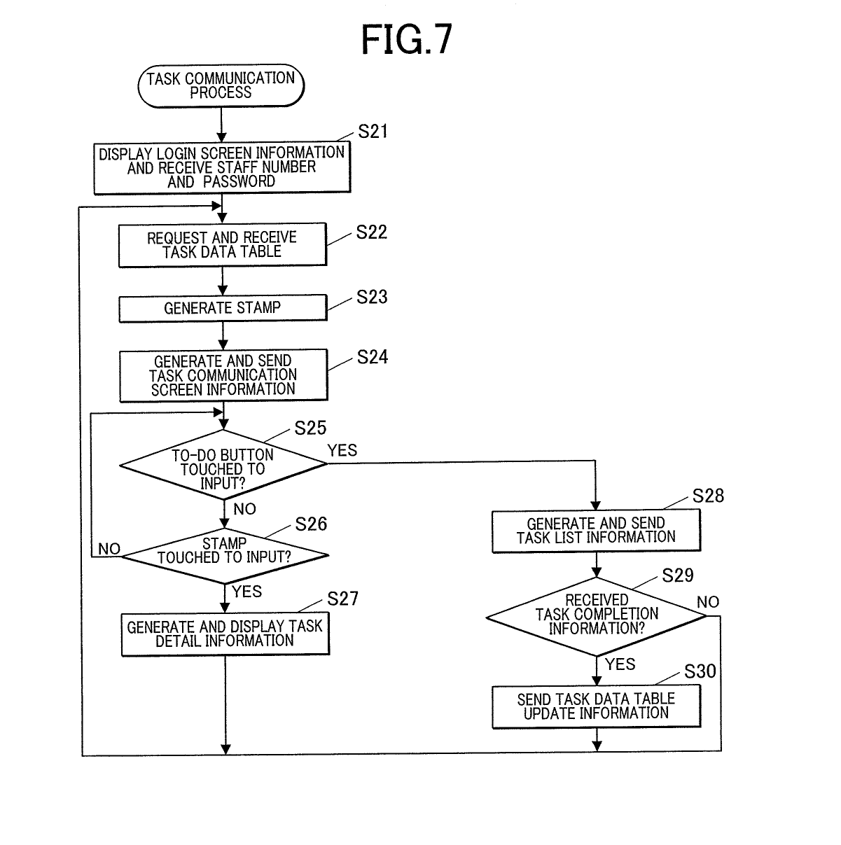

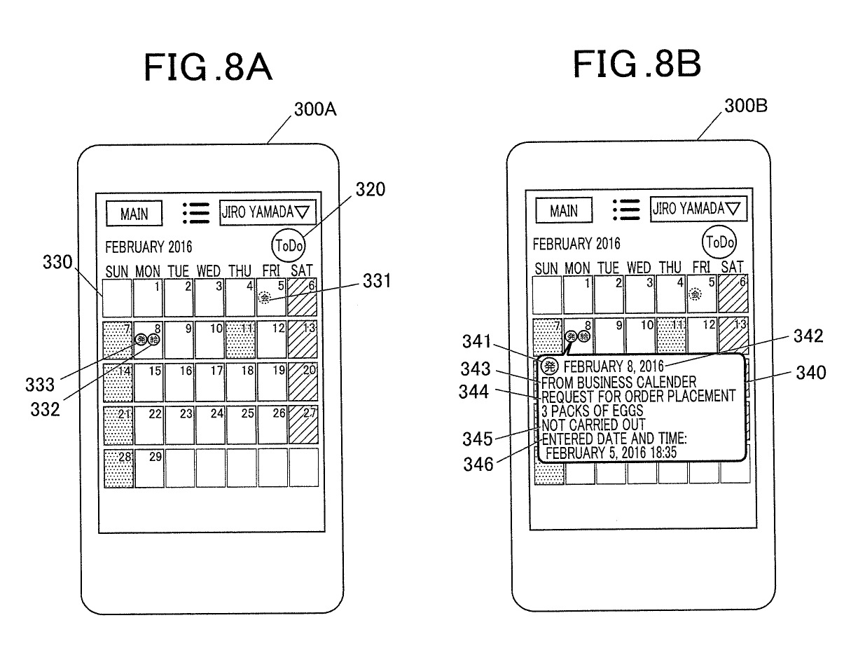

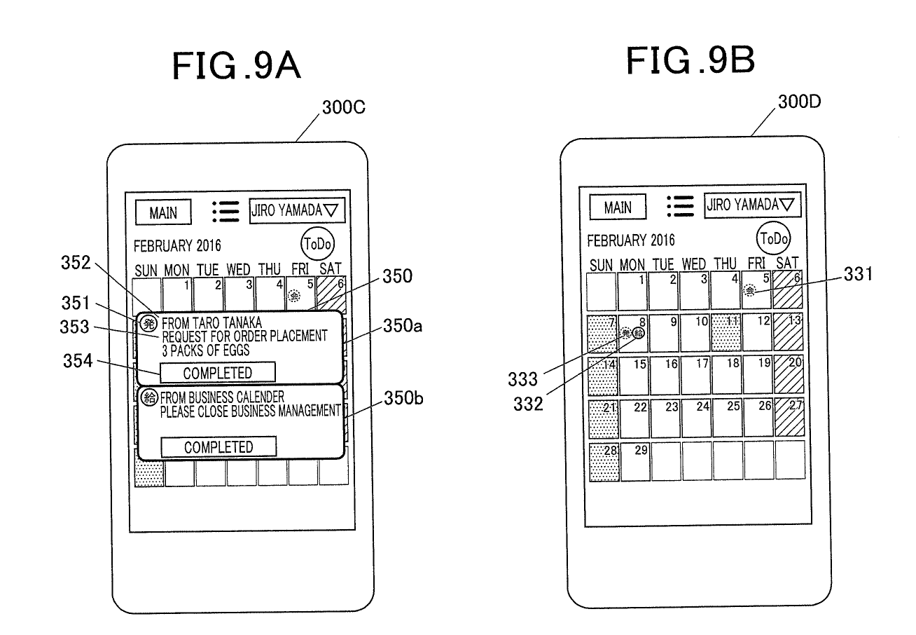

With reference to FIGS. 6 to 9B, the operation of the task management system 1 will be described. FIG. 6 is the flowchart of the information display input process. FIG. 7 is the flowchart of the task communication process. FIG. 8A shows the task communication screen 300A. FIG. 8B shows the task communication screen 300B. FIG. 9A shows the task communication screen 300C. FIG. 9B shows the task communication screen 300D.

With reference to FIG. 6, the information display input process which is carried out in a terminal device 20 will be described. The information display input process is a process to carryout display of the display information relating to the task communication process and to carryout input and receiving of information. In a terminal device 20, input of an instruction to carryout the information display input process by a user via the operating unit 22 being the trigger, the CPU carries out the information display input process in cooperation with the information display input program 251 which is read out from the storage 25 and deployed in the RAM 23.

The CPU 21 determines whether an instruction to end the information display input process is input via the operating unit 22 (step S11). If the CPU 21 determines that the instruction to end the process is input (step S11; YES), the CPU 21 ends the information display input process. If the CPU 21 determines that the instruction to end the process is not input (step S11; NO), the CPU 21 determines whether display information is received from the server 10 via the wireless communicator 26 (step S12).

If the CPU 21 determines that display information is received (step S12; YES), the CPU 21 displays the display information which is received in step S12 (step S13). Then, the CPU 21 determines whether information is input through operation inputs other than the instruction to end the process via the operating unit 22 (step S14). If the CPU 21 determines that the display information is not received (step S12; NO), the CPU 21 proceeds to step S14.

If the CPU 21 determines that the information is input (step S14; YES), the CPU 21 sends the input information (operating information, text information, audio information, etc.) which is input in step S14 to the server 10 via the wireless communicator 26 (step S15) and proceeds to step S11. If the CPU 21 determines that the information is not input (step S14; NO), the CPU 21 proceeds to step S11.

With reference to FIGS. 7 to 9B, the task communication process which is carried out in the server 10 will be described. The task communication process is a process to show the tasks relating to the staffs at the restaurant which are input through the business supporting server 30 in the calendar information in the form of stamps as stamp marks in order to communicate among the staffs about the tasks. The calendar information is a schedule template including a plurality of display areas that are respectively associated with predetermined date information or time zone information. In the embodiment, the calendar information is a view display where the display areas are shown by dates and the dates are arranged according to time sequence.

In the terminal device 20 of a staff, an instruction to execute the task communication process is input in accordance with step S14 of the information display input process in FIG. 6 and the instruction to execute the task communication process is sent to the server 10 in step S15. Then, in the server 10, receiving of the instruction to execute the task communication process from the terminal device 20 via the communicator 16 in accordance with step S15 of the information display input process in FIG. 6 being the trigger, the CPU 11 carries out the task communication process in cooperation with the task communication program 151 which is read out from the storage 15 and deployed in the RAM 13.

First, the CPU 11 generates login screen information, sends the generated login screen information to the terminal device 20 which is in communication via the communicator 16 and makes the terminal device 20 display the login screen information in accordance with steps S12 and S15 of the information display input process in FIG. 6. The CPU 11 further receives the staff number as the login ID and the password from the terminal device 20 which is in communication, reads out the account data table 40 from the storage 15 and carries out login authentication by using the received staff number and password and the account data table 40 (step S21). The login screen information includes areas for inputting the login ID and the password.

In accordance with step S21, the CPU 21 of the terminal device 20 receives and displays the login screen information in steps S12 and S13 in FIG. 6, inputs the staff number as the login ID and the password via the operating unit 22 and sends the input information to the server 10 in steps S14 and S15 in FIG. 6. The CPU 11 carries out the login authentication on the basis of whether the received staff number and password are in the records of staff number 41 and password 45 in the account data table 40.

Then, the CPU 11 sends the request for the task data table 50 to the business supporting server 30 via the communicator 16 and receives the task data table 50 from the business supporting server 30 (step S22). In accordance with step S22, the CPU (not shown) of the business supporting server 30 receives the request for the task data table 50 from the server 10 via its communicator (not shown), reads out the task data table 50 from its storage (not shown) and sends the task data table 50 to the server 10 via the communicator. At this time, if the task data table 50 includes a file name of an attached file 62, the CPU of the business supporting server 30 reads out the file name of the attached file 62 from the storage and sends the task data table 50 and the attached file to the server 10 via the communicator. The CPU 11 receives the task data table 50 (and the attached file) from the business supporting server 30 via the communicator 16.

Then, with respect to each record in the task data table 50 received in step S22, the CPU 11 generates stamp image data (stamp image) in a display manner of an enclosed letter or an enclosed character where the first letter of its corresponding task content 60 is encircled and make the stamp image be associated with the task number 51 (step S23). In step S23, with respect to each record in the task data table 50, the CPU 11 generates a stamp image in a display manner where the first letter of its corresponding task association 61 being encircled if the task association 61 indicates a business application name. With respect to the stamp images, each of them is in the manner where one letter is encircled. However, this manner is not limitative in any way. For example, the stamp images may be in the manner of combinations of other shapes such as squares and the letters.

Thereafter, the CPU 11 obtains the current date and time information from the counter 17, reads out the task data table 50 from the storage 15, generates the task communication screen information corresponding to the user who is authenticated in step S11 by using the current date and time information, the account data table 40, the task data table 50 and the stamp images generated in step S23, sends the generated task communication screen information to the terminal device 20 which is in communication via the communicator 16 in accordance with step S12 in FIG. 6 and makes the terminal device 20 display the task communication screen information (step S24).

In step S24, the CPU 11 prepares the calendar information of the current month corresponding to the current time information and then, with respect to the task records in the task data table 50 whose deadlines 56 are in the current month, “yes” or “no” is indicated for whether to inform all staffs other than the person who made the entry 63 and the logged in user is the the person who made the entry 53, the CPU 11 places the stamp images which are generated in step S23 on the dates of the deadlines 56 in the calendar information. The CPU 11 generates the task communication screen information including the display region of the calendar information in which the stamps are placed, the display region of the name 42 of the staff who is logged in, and the after-mentioned to-do button. Although the stamps in the calendar information are shown in the basic color such as black, it is preferred that different display colors are set according to completed/not completed 57 and whether the person who made the entry 53 is the logged in user. Further, with respect to the plurality of stamps which are placed on the same date in the calendar information, they are to be listed in descending order according to their importance 54 level.

In accordance with step S24, the CPU 21 of the terminal device 20 receives and displays the task communication screen information in step S12 and S13 in FIG. 6. In step S22, the task communication screen information showing the task communication screen 300A shown in FIG. 8A is generated, for example. The task communication screen 300A is the screen corresponding to the case where the tasks whose task numbers 51 are 1 to 3 in the task data table 50 shown in FIG. 5B are entered.

The task communication screen 300A includes the logged in user display region 310, the to-do button 320 and the calendar display region 330. The logged in user display region 310 is the region for showing the logged in user. The task communication screen 300A is an example where the logged in user shown in the logged in user display region 310 is Jiro Yamada who is the manager. The to-do button 320 is the button for receiving the input for showing the list of the tasks whose deadlines are the day of login.

The calendar display region 330 is the display region for the calendar information in which the stamps of the tasks are shown on the dates of their deadlines in the calendar of the logged in month. The calendar display region 330 includes the stamp 331 corresponding to the task relating to the accounting service, the stamp 332 corresponding to the task relating to the salary payment service and the stamp 333 corresponding to the task relating to order placement, for example. The importance 54 level of the stamp 333 is higher than that of the stamp 332, thus the stamp 333 is placed before the stamp 332 in the date area of Feb. 8, 2016. The stamps in the calendar display region 330 can be input by a user carrying out a touch input.

In accordance with step S24, the CPU 21 of the terminal device 20 receives an input carried out on the to-do button 320 or a stamp in the calendar display region 330 via the operating unit 22 and sends the input information to the server 10 in steps S14 and S15 in FIG. 6.

Then, in accordance with step S15 in FIG. 6, the CPU 11 determines whether the to-do button 320 is touched to input according to whether the touch input information of the to-do button 320 is received from the terminal device 20 which is in communication via the communicator 16 (step S25). If the CPU 11 determines that the to-do button 320 is not touched to input (step S25; NO), the CPU 11, in accordance with step S15 in FIG. 6, determines whether a stamp in the calendar display region 330 is touched to input according to whether the touch input information of a stamp in the calendar display region 330 is received from the terminal device 20 which is in communication via the communicator 16 (step S26).

If the CPU 11 determines that a stamp is touched to input (step S26; YES), the CPU 11 generates task detail information corresponding to the task relating to the stamp which is touched to input on the basis of the task data table 50 stored in the storage 15 and the memo information (if received in step S22), sends the task detail information to the terminal device 20 which is in communication, makes the terminal device 20 display the task detail information (step S27) and proceeds to step S22. The task detail information includes the stamp image, the deadline 56, the person who made the entry 53, the task content 60, the memo information, whether the task is completed/not completed 57 and the entered date and time 55 relating to the stamp which is touched to input, for example. In accordance with step S25, the CPU 21 of the terminal device 20 receives and displays the task detail information in steps S12 and S13 in FIG. 6.

In step S27, the task detail information showing the task detail information display region 340 of the task communication screen 300B shown in FIG. 8B is generated, for example. The task detail information display region 340 includes the stamp display region 341, the deadline display region 342, the display region for the person who made the entry 343, the task content display region 344, the completion display region 345 and the entered date and time display region 346.

The stamp display region 341 is the display region for the stamp image of the stamp which is input. The deadline display region 342 is the display region for the deadline 56 of the task corresponding to the stamp which is input, the deadline being indicated in the task data table 50. The display region for the person who made the entry 343 is the display region for the person who made the entry 53 of the task corresponding to the stamp which is input. The task content display region 344 is the display region for the task content 60 of the task corresponding to the stamp which is input. The completion display region 345 is the display region for an indication whether the task corresponding to the stamp which is input is completed/not-completed 57. The entered date and time display region 346 is the display region for the entered date and time 55 of the task corresponding to the stamp which is input.

If the CPU 11 determines that a stamp is not input (step S26; NO), the CPU 11 ends the task communication process. If the CPU 11 determines that the to-do button 320 is input (step S25; YES), the CPU 11 obtains the current date and time information from the counter 17, generates task list information including the list information of not-completed tasks on the basis of the task data table 50 and the current date and time information, sends the generated task list information to the terminal device 20 which is in communication and makes the terminal device 20 display the task list information in accordance with step S12 in FIG. 6 (step S28).

In accordance with step S28, the CPU 21 of the terminal device 20 receives and displays the task list information in steps S12 and S13 in FIG. 6. In step S28, the task list information of the task list display region 350 included in the task communication screen 300C shown in FIG. 9A is generated, for example. The task list display region 350 includes the task information display regions 350a and 350b showing, in task units, the tasks whose deadlines are today, “yes” or “no” is indicated for whether to inform staffs other than the person who made the entry, which were entered by the logged in user and which are not completed yet. The task information display regions 350a and 350b respectively correspond the tasks relating to the order placement stamp 333 and the salary payment service stamp 332. Further, each of the task information display regions 350a and 350b includes the stamp display region 351, the display region for the person who made the entry 352, the task content display region 353 and the completed button 354.

The stamp display region 351 is a region for showing the stamp image corresponding to the task where the date of the current date and time information is the deadline 56 indicated in the task data table 50, “yes” or “no” is indicated for whether to inform all staffs other than the person who made the entry 63, the person who made the entry 53 is the logged in user and “not completed” is indicated for the completed/not completed 57 information. The display region for the person who made the entry 352 is the display region for the person who made the entry 53 of the task corresponding to the stamp shown in the stamp display region 351. The task content display region 353 is the display region for the task content 60 of the task corresponding to the stamp shown in the stamp display region 351. The completed button 364 is the button for receiving, with respect to the task corresponding to the stamp shown in the stamp display region 361, the touch input indicating that the task is completed via the operating unit 22 after the task is carried out and completed by the logged in user.

Then, in accordance with step S37, the CPU 21 of the terminal device 20 receives the touch input carried out on the completed button 364 in the task list display region 350 via the operating unit 22 and sends the task completion information corresponding to the input to the server 10 in steps S14 and S15 in FIG. 6. Here, for example, it is assumed that the touch input is carried out on the completed button 364 in the task information display region 360a by Saburo Suzuki who completed the task and the task completion information is sent to the server 10.

In accordance with step S15 in FIG. 6, the CPU 11 determines whether the task completion information is received from the terminal device 20 which is in communication via the communicator 16 (step S29). If the CPU 11 determines that the task completion information is not received (step S29; NO), the CPU 11 proceeds to step S22. If the CPU 11 determines that the task completion information is received (step S29; YES), the CPU 11 sends the task completion information to the business supporting server 30 via the communicator 16, makes the business supporting server 30 update the task data table 50 (step S30) and proceeds to step S22. The task completion information includes the task number, the name 42 of the logged in user, the date and time information of the current date and time information and the information indicating that the task is completed. In accordance with step S30, the CPU of the business supporting server 30 receives the task completion information from the server 10 via the communicator and in accordance with the task completion information, the CPU updates the task data table 50 stored in the storage.

Here, an updating example of the task data table 50 in a case where a task is completed in step S30 will be described. For example, it is assumed that the logged in user is Jiro Yamada who is the manager, a touch input is carried out on the completed button 354 corresponding to the task shown in the task information display region 350a and the task completion information includes the task number of the order placement task corresponding to the stamp 333, the name, Jiro Yamada, and the information indicating that the task is completed. In step S30, the completed/not completed 57 information of the record whose task number 51 is 3 in FIG. 5 is updated to “completed”, the person who carried out the task 58 is updated to the name, Jiro Yamada, and the task completed date 59 is updated to the current date information.

Then, in accordance with step S22, the task communication screen information of the task communication screen 300D shown in FIG. 9B is generated and is displayed in Jiro Yamada's terminal device 20. In the task communication screen 300D, the stamp 333 is shown in the color indicating that the task is completed similarly to the stamp 331 (for example, in the display color lighter that the reference display color) in the calendar display region 330.

As described above, according to the embodiment, the server 10 receives the entry of the task data table 50 as the task information including a task content 60 which is the letter string information as the task content information from the business supporting server 30. If the server 10 receives the task data table 50, the server 10 generates the stamp on the basis of the task content 60 in the task data table 50, places the generated stamp in the calendar display region 330 as a predetermined schedule template, sends the calendar display region 330 in which the stamp is placed to the terminal device 20 and makes the terminal device 20 display the calendar display region 330.

By generating and displaying a stamp which is task information that can be visually recognized and understood easily with respect to a task including a task content 60, the task being managed by the business supporting server 30, the content of the task which needs to be carried out can be recognized easily and the users can be supported so as to assure that the task will be carried out.

If a selecting operation is carried out through the terminal device 20 to a stamp which is placed and shown in the calendar display region 330, the server 10 sends the task content 60 corresponding to the stamp to which the selecting operation is carried out to the terminal device 20 and makes the terminal device 20 display the task content 60. Therefore, the content information of the task corresponding to the selected stamp can be recognized easily.

The server 10 further generates a stamp mark so as to include at least a part of the letters in the task content 60 as a part of the stamp. Therefore, by a letter in the task content 60 being included in the stamp, the task content can, at least roughly, be recognized easily.

The server 10 receives entry of the task data table 50 as the task information including task association 61 which is the identification information for identifying the application which is to be activated when carrying out a task. If the server 10 receives the entry of the task data table 50, the server 10 generates or selects a stamp on the basis of the task association 61 corresponding to the task data table 50, places the generated or selected stamp in the calendar display region 330 as a predetermined schedule template, sends the calendar display region 330 in which the stamp is placed to the terminal device 20 and makes the terminal device 20 display the calendar display region 330. By generating and displaying a stamp which is task information that can be visually recognized and understood easily with respect to a task corresponding to an application managed by the business supporting server 30, the content of the task which needs to be carried out can be recognized easily and the users can be supported so as to assure that the task will be carried out.

The task association 61 includes name information of the application, and the server 10 generates a stamp so as to include at least a part of the letters in the name information as a part of the stamp. By a part of the letters in the business association 61 being included in the stamp, the task content can, at least roughly, be recognized easily.

The server 10 also receives the entry of the deadline 56 as the deadline by when the task needs to be carried out when receiving the entry of the task data table 50 from the business supporting server 30, places the stamp in the display area in the calendar display region 330 corresponding to the deadline 56 whose entry was received, sends the calendar display region 330 in which the stamp is placed in the display area to the terminal device 20 and makes the terminal device 20 display the calendar display region 330. By generating a stamp which is task information that can be visually recognized easily with respect to a task which is managed by the business supporting server 30 and displaying the generated stamp in the display area corresponding to the deadline, the content of the task which needs to be carried out and the deadline of the task which needs to be carried out can be recognized easily and the users can be supported so as to assure that the task will be carried out.

In the above description, an example where a HDD or a SSD in the storage 15 is used as the computer readable recording medium of the program according to the present invention is disclosed. However, this example is not limitative in any way. As for other computer readable recording medium, portable recording medium such as a flash memory, a CD-ROM or the like can be used. Further, as a medium for providing the data of the program according to the present invention via the communication line, a carrier wave can be used in the present invention.

The above description of the embodiment is an example of the task management device and the task management method according to the present invention and the embodiment is not limitative in any way.

For example, in the above embodiment, the task completion information of the task whose deadline is today and which is not yet completed shown in the task list information is to be input after the to-do button is touched to input. However, this is not limitative in any way. The task list information may include the information of the tasks whose deadlines are today or after today so that the task completion information of the tasks whose deadlines are today or after today can be input. Further, the completed button may be included in the detail information of the task which is displayed when a stamp is touched to input so that the task completion information of the task can be input by the completed button being touched to input.

In the above embodiment, an example where the task management system 1 is applied to a catering business (restaurant) is described. However, this is not limitative in any way. The task management system 1 can be applied to other types of businesses.

In the above embodiment, the person who makes the entry does not specify the person who carries out the task. However, this is not limitative in any way. The person who makes the entry may be able to specify the person who carries out the task.

In the above embodiment, the deadline of a task is set to the date by when the task needs to be carried out. However, this is not limitative in any way. The deadline of a task may be set to the date during which the task needs to be carried out. Further, the display of the stamps relating to the tasks may be in different manners according to the above two types of deadlines (for example, the display color may be different).

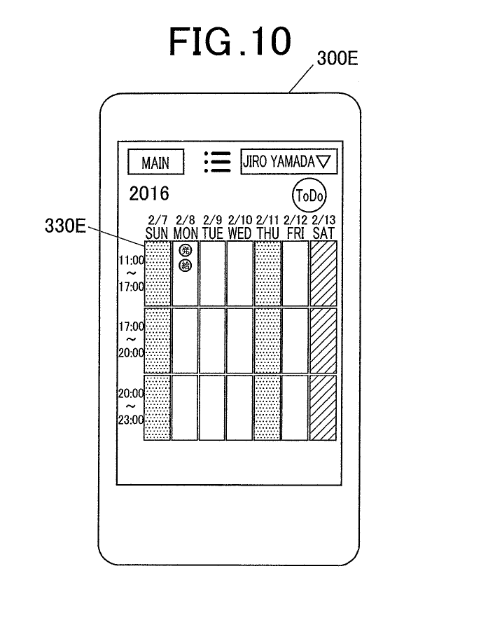

In the above embodiment, the calendar display region 330 in the task communication screen 300A shown in FIG. 8A or the like is the region for displaying the calendar information as the schedule template including dates as display areas. However, this is not limitative in any way. The task communication screen 300E as shown in FIG. 10 may be displayed in the terminal device 20. FIG. 10 shows the task communication screen 300E.

The task communication screen 300E includes the calendar display region 330E. The calendar display region 330E is the region for displaying the calendar information as the schedule template including time zones for each date as display areas. In such way, with respect to the calendar information as the schedule template, display areas may be set in other ways such as according to am and pm of each date, by weeks, by months, etc.

In the above embodiment, a stamp using a letter of a predetermined position in the task association 61 (the first letter) is generated with respect to a task to which an application is set and indicated in the task association 61 and a stamp using a letter of a predetermined position (the first letter) in a task content 60 is generated with respect to a task to which an application is not set and indicated in the task association 61 in step S23 in FIG. 7. However, this is not limitative in any way.

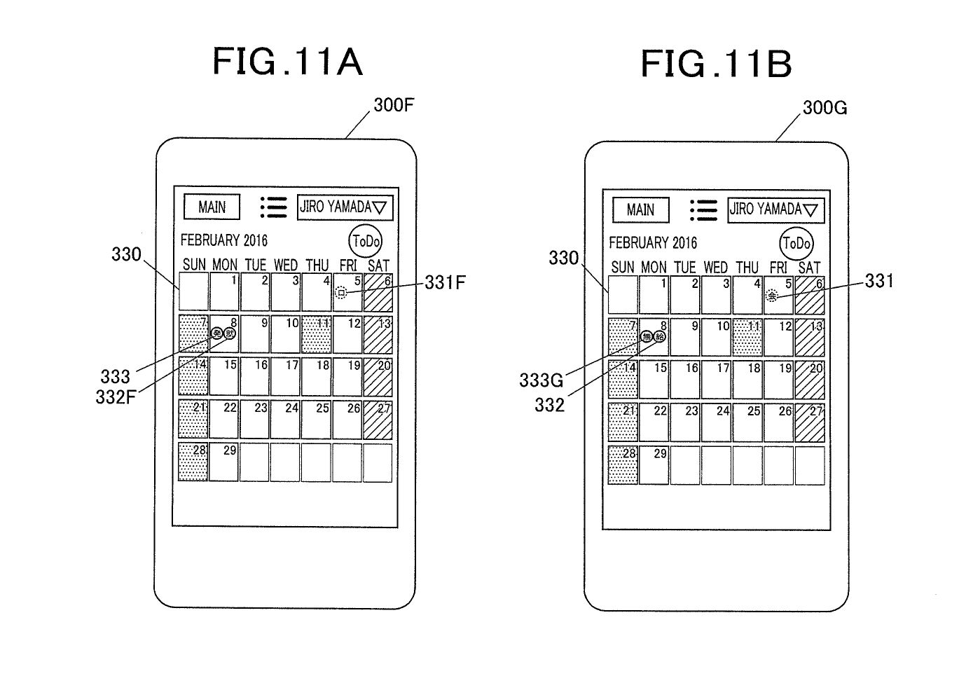

For example, stamps may be generated for all of the tasks by using the letters of predetermined positions (the first letters) of the task contents 60 corresponding to the tasks in step S23 in FIG. 7. In such configuration, for example, in step S24, the task communication screen 300F shown in FIG. 11A is displayed in the terminal device 20 instead of the task communication screen 300A shown in FIG. BA. FIG. 11A shows the task communication screen 300F. The task communication screen 300F includes the calendar display region 330 in which the stamps 311F, 332F and 333 are placed. Although the stamp 331F is the stamp corresponding to the task whose task number 51 is “1” in the task data table 50, different from the stamp 331, the stamp 331F is shown in the manner where the first letter “ [symbol] ” in “ [symbol] [symbol] ” which means “BANK TRANSACTION CONFIRMATION” in the task content 60 is encircled. Although the stamp 332F is the stamp corresponding to the task whose task number 51 is “2” in the task data table 50, different from the stamp 332, the stamp 332F is shown in the manner where the first letter “ [symbol] ” in “ [symbol] [symbol] ” which means “PLEASE CLOSE BUSINESS MANAGEMENT” in the task content 60 is encircled.

Further, for example stamps may be generated for all of the tasks by using the letters of predetermined positions (the first letters) in the task association 61 in step S23 in FIG. 7. In such configuration, the task communication screen 300G shown in FIG. 11B is displayed in the terminal device 20 instead of the task communication screen 300A shown in FIG. 8A in step S24, for example. FIG. 11B shows the task communication screen 300G. The task communication screen 300G includes the calendar display region 330 in which the stamps 331, 332 and 333G are placed. Although the stamp 331G is the stamp corresponding to the task whose task number 51 is “3” in the task data table 50, different from the stamp 333, the stamp 331G is shown in the manner where the first letter “ [symbol] ” in “ [symbol] ” which means “NO” indicated in the task association 61 of the task is encircled.

Furthermore, for example stamps may be generated for all of the tasks by using initials of any keywords in the task contents 60 and the task association 61 in step S23 in FIG. 7.

With respect to the detail structure and the detail operation of individual components of the task management system 1 of the embodiment, they can be modified as needed within the scope of the invention.

Although an embodiment of the present invention is described above, the scope of the invention is not limited by the above described embodiment. The scope of the invention is defined by the claims and the equivalents thereof.

The entire disclosure of Japanese Patent Application No. 2016-058530 filed on Mar. 23, 2016 is incorporated herein by reference in its entirety.

What is claimed is:

1. A task management device, comprising:
a first receiver which receives an entry of task information including letter string information as content information of a task; and
a first display controller which, in a case where the first receiver receives the entry of the task information, generates a stamp mark on a basis of the letter string information in the task information, places and shows the generated stamp mark in a predetermined schedule template.

2. The task management device of claim 1, comprising a second display controller which, in a case where a selecting operation is carried out on the stamp mark which is placed and shown by the first display controller, controls a display to display the letter string information corresponding to the stamp mark on which the selecting operation is carried out.

3. The task management device of claim 2, further comprising:
a second receiver which, among tasks corresponding to stamp marks placed and shown by the first display controller, receives an input of task completion information indicating a task which is carried out and completed among not-completed tasks, wherein
the second display controller controls the display to display a completion condition of the task corresponding to the stamp mark on which the selecting operation is carried out on a basis of the task completion information input by the second receiver.

4. The task management device of claim 2, wherein the second display controller controls the display to display a callout area so as to be associated with the stamp mark on which the selecting operation is carried out and to display the letter string information in a region defined by the callout area.

5. The task management device of claim 4, wherein the second display controller controls the display to display the stamp mark on which the selecting operation is carried out in the region defined by the callout area.

6. The task management device of claim 5, wherein the second display controller controls the display to display the stamp mark which is displayed in the region defined by the callout area in a larger size than the stamp mark on which the selecting operation is carried out.

7. The task management device of claim 1, wherein the first display controller generates the stamp mark so as to include at least a part of letters in the letter string information as a part of the stamp mark.

8. The task management device of claim 1, wherein
the first receiver receives an entry of a deadline of the task when receiving the entry of the task information, and
the first display controller places and shows the stamp mark in a display area corresponding to the deadline whose entry is received by the first receiver.

9. A task management device, comprising:
a first receiver which receives an entry of task information including identification information for identifying an application which is activated when carrying out a task; and
a first display controller which, in a case where the first receiver receives the entry of the task information, generates or selects a stamp mark on a basis of the identification information corresponding to the task information, and places and shows the stamp mark which is generated or selected in a predetermined schedule template.

10. The task management device of claim 9, wherein
the identification information includes name information of the application, and
the first display controller generates the stamp mark so as to include at least a part of letters in the name information as a part of the stamp mark.

11. The task management device of claim 9, wherein
the first receiver receives an entry of a deadline of the task when receiving the entry of the task information, and
the first display controller places and shows the stamp mark in a display area corresponding to the deadline whose entry is received by the first receiver.

12. A task management method, comprising:
first receiving to receive an entry of task information including letter string information as content information of a task; and
first display controlling in which, in a case where the entry of the task information is received in the first receiving, a stamp mark is generated on a basis of the letter string information in the task information, and the generated stamp mark is placed and shown in a predetermined schedule template.

13. The task management method of claim 12, further comprising second display controlling in which, in a case where a selecting operation is carried out on the stamp mark which is placed and shown in the first display controlling, the letter string information corresponding to the stamp mark on which the selecting operation is carried out is displayed.

14. The task management method of claim 13, further comprising:
second receiving in which, among tasks corresponding to stamp marks placed and shown in the first display controlling, an input of task completion information indicating a task which is carried out and completed among not-completed tasks is received, wherein
in the second display controlling, a completion condition of the task corresponding to the stamp mark on which the selecting operation is carried out is displayed on a basis of the task completion information input by the second receiver.

15. The task management method of claim 13, wherein in the second display controlling, a callout area is displayed so as to be associated with the stamp mark on which the selecting operation is carried out and the letter string information is displayed in a region defined by the callout area.

16. The task management method of claim 15, wherein in the second display controlling, the stamp mark on which the selecting operation is carried out is displayed in the region defined by the callout area.

17. The task management method of claim 16, wherein in the second display controlling, the stamp mark which is displayed in the region defined by the callout area is in a larger size than the stamp mark on which the selecting operation is carried out.

18. The task management method of claim 12, wherein in the first display controlling, the stamp mark is generated so as to include at least a part of letters in the letter string information as a part of the stamp mark.

19. The task management method of claim 12, wherein
in the first receiving, an entry of a deadline of the task is received when receiving the entry of the task information, and
in the first display controlling, the stamp mark is placed and shown in a display area corresponding to the deadline whose entry is received by the first receiver.
